(19) United States
(12) Patent Application Publication
(10) Pub. No.: US 2004/0090441 A1
(43) Pub. Date: May 13, 2004

(54) Method and device for translating two-dimensional data of a discrete wavelet transform system

(76) Inventors: Wen-Yu Su, Tainan (TW); Wen-Bin Huang, Kaohsiung (TW); Yau-Hwang Kuo, Tainan (TW)

Correspondence Address: DELLETT AND WALTERS, 310 S.W. FOURTH AVENUE, SUITE 1101, PORTLAND, OR, 97204, US

(21) Appl. No.: 10/290,552

(22) Filed: Nov. 7, 2002

(51) Int. Cl. G06T 1/00; G06F 15/00

(52) U.S. Cl. 345/501

(57) ABSTRACT

A method for translating two-dimensional data of a DWT system has a stairway scan way with a border extension to translate a two-dimensional data to at least two one-dimensional data to be able to execute in the Wavelet transform. The one-dimensional data with less extension data in executing the wavelet transform not only uses small size memory but also has high transforming speed. Therefore the two-dimensional data is compressed by the wavelet transform with the boundary extension process according to the present invention has good compressed rate.

### BACKGROUND OF THE INVENTION

1. Field of the Invention

The present invention relates to a method and a device for translating two-dimensional data of a discrete wavelet transform (DWT) system, more specifically to a translating two-dimensional data method for a DWT system that provides a more effective translating process for data compression.

2. Description of Related Art

The JPEG Committee proposed static image compression in 1988. Encoding technology to compress data often uses DCT (discrete cosine transform). The discrete cosine transform (DCT) is a conventional transform technology used in image compression system. In order to increase compressing rate of the image, more significant signals of the image is lost in the DCT so that JPEG Committee replaced DCT by DWT, which has less loss of the significant signals in the same condition with the DCT and has a good transforming quality.

The DWT has a variety of filters and the JPEG Committee suggests two of the filters to use, one is Integer 5/3 and the other is Daubechines 9/7 (CDF 9/7). The Integer 5/3 and Daubechines 9/7 (CDF 9/7) filters respectively have one fixed length. There are two kinds of implementing methods of the Integer 5/3 and Daubechines 9/7 (CDF 9/7) filters, one method is a sub-bank transform and the other is a lifting scheme. Implementing the sub-bank transform requires more electronic elements and more memory requirement because the sub-bank layout circuit is more complex. The lifting scheme was proposed in 1996. The lifting scheme built an orthogonal wavelet to quickly translate data by a small translation. Implementing the lifting scheme requires fewer electronic elements and less memory requirement and is easier than implementing the sub-bank transform. Thus JPEG2000 suggested that the lifting scheme is used to implement the wavelet translation.

With reference to FIG. 8, a conventional embodiment of the lifting scheme has an input sequence x[k], a low frequency output sequence “y_{low}” and a high frequency output sequence “y_{high}”.

With further reference to FIG. 9, the lifting scheme has the following steps:

1. Splitting step to split the input sequence into two portions, y₀^{{0}}[n] and y₁^{{0}}[n]. One portion y₀^{{0}}[n] defines an even number set of the input sequence and the other portion y₀^{{0}}[n] defines an odd number set of the input sequence. The two portions, y₀^{{0}}[n] and y₁^{{0}}[n], of the input sequence are respectively described in a formula as follows:

y₀^{{0}}[n]=x[2n]

y₁^{{0}}[n]=x[2n+1]

2. Predicting step to calculate a second odd number set by the first even number set. Specifically, each odd number is calculated as follows:

(a) Averaging the two adjacent even numbers; and

(b) Adding the average and a first odd number to obtain a second odd number.

The foregoing calculation can be mathematically described as follows:

y₀^{{1}}[n]=y₀^{{0}}[n]

$${y}_{1}^{\{ 1 \}} [ n ] = {y}_{1}^{\{ 0 \}} [ n ] + {\sum }_{i} {λ}_{l o w} [ i ] {y}_{0}^{\{ 0 \}} [ n - i ]$$

3. Recalculating the even number set based on the second odd number set. That is, each even number is calculated as follows:

(a) Averaging the two adjacent second odd numbers; and

(b) Adding the average and a first even number to obtain a second even number.

The foregoing calculation can be mathematically described as follows:

$${y}_{0}^{\{ 1 \}} [ n ] = {y}_{0}^{\{ 0 \}} [ n ] + {\sum }_{i} {λ}_{h i g h} [ i ] {y}_{1}^{\{ 0 \}} [ n - i ]$$

y₁^{{1}}[n]=y₁^{{0}}[n]

4. Repeating the forgoing steps 2 and step 3. Number for repeating is based on an implemented wavelet filter. The repeating number is assumed to m.

5. Normalization step to complete a low frequency and a high frequency sequence y_{low}, y_{high} of the lifting scheme. Two different numbers K₀ and K₁ are respectively multiply the m'th even number set and the m'th odd number set as follows:

y_{low}=y₀^{{m}}{n}×K₀

y_{high}=y₁^{{m}}{n}×K₁

With reference to FIG. 10, a wavelet Integer 5/3 filter is an example used to implement the foregoing steps. First both of the two different numbers K₀ and K, are defined to 1 in the normalization step. The step 2 and step 3 are only executed once. The low frequency and high frequency output sequences y_{low}, y_{high} are respectively calculated as

$$\begin{matrix}{y}_{l o w} = {y}_{1}^{\{ 0 \}} [ n ] - \frac{1}{2} ( {y}_{0}^{\{ 0 \}} [ n ] + {y}_{0}^{\{ 0 \}} [ n + 1 ] ) \\ {y}_{h i g h} = {y}_{1}^{\{ 1 \}} [ n ] + \frac{1}{4} ( {y}_{1}^{\{ 1 \}} [ n ] + {y}_{1}^{\{ 1 \}} [ n - 1 ] )\end{matrix}$$

With reference to FIG. 11, a wavelet CDF 9/7 filter is other example to implement the foregoing steps. The predicting step and the updating step need to be executed twice to obtain the low frequency and high frequency output sequences y_{low}, y_{high}. The low frequency and the high frequency output sequences are described by the Z translation in the digital signal process (DSP) as follows:

λ₁(z)=−1.586134342(1+z)

λ₂(z)=−0.052980118(1+z⁻¹)

λ₃(z)=0.882911075(1+z)

λ₄(Z)=0.443506852(1+z⁻¹);

where k₀=k, k₁=1/k, and k=1.149604398.

The foregoing description describes how one input sequence is translated to the low frequency and the high frequency output sequences by wavelet translating with the lifting scheme. However, the quality of two-dimensional data must be further considered when translating two-dimensional data by wavelet translation. Next, the DWT for translating the two-dimensional data, such as an image, is further introduced. In the image compression technology, an original image is first translated by DWT and then is further compressed and encoded to a compressed data. When the compressed data is returned to the original image, the compressed data is reversal calculated to obtain a two-dimension data whose boundary differs from the original image's. Therefore, a boundary extension process is executed before the DWT to ensure that quality of boundary of the original image.

One kind of the boundary extension process called a symmetric extension is used in JPEG2000. The symmetric extension has two different process methods. With reference to FIG. 12A, a data stream having odd bit numbers is processed by the one symmetric extension. Two extended data streams respectively are mirror images of the data stream and are appended before a first bit and after a last bit of the data stream. The number of bits in the extended data stream is defined based on the length of the filter of wavelet technology. In FIG. 12A, the length of filter is defined to four bits long, so that the bit number of the extended data stream is four. With reference to FIG. 12B, a data stream having even bit numbers is processed by the other symmetric extension. Two extended data streams respectively are also mirror images and extend from two centers, a first bit and a last bit of the data stream. The number of bits in the extended data stream is defined based on the length of the filter of the wavelet technology.

With reference to FIG. 13A, a first image (50) is a two-dimensional data composed of rows and columns. Each row or each column of an example first image (50) is composed of 8 pixels. Thus the first image (50) is composed of 8×8 pixels.

The first image (50) is translated by wavelet translation in the following steps. First, the first image is processed by the second symmetric extension, wherein the length of the filter of the wavelet technology is four bits long.

1. Extending two extended data streams (60) each with four mirror reflecting pixels respectively from a first pixel and a last pixel of each row to generate a second image (not numbered) which is composed of 16×8 pixels, as shown in FIG. 13B.

2. Translating the second image by inputting each row with two extended data streams until the last row to the lifting scheme.

3. Extending two data streams each with four mirror reflecting pixels respectively from a first pixel and a last pixel of each column to generate a third image (not numbered) which is composed of 16×16 pixels, as shown in FIG. 13C.

4. Translating the third image by inputting each column with two extended data streams until the last column to the Lifting scheme.

The above translating process with the symmetric extension provides a good translated result to compress image without boundary effect. A one-dimensional data is requested in the Lifting scheme so that each row and each column have to be process by the symmetric extension. Thus, lots of memory is needed in the translating process, which causes the overall calculating speed to be slow. Furthermore, implementing a circuit to perform the translation also requires more electronic devices.

A conventional data compression system basically has a DWT unit and an Entropy coding unit. The original image is translated by the DWT unit and then is coded to a compressed data, which is stored in small memory to be easy transmitted. When returning the compressed data to the image, the compressed data is input to an inverse data compression system including an Inverse Entropy coding unit and an Inverse DWT unit to obtain a reconstruct image. In general, if the data compression system has a compressing quality, the reconstruct image is very similar to the original image. If the data compression system has high compressing rate, a size of the reconstruct image is smaller than the original image's.

Therefore, the present invention provides a method for translating two-dimensional data having a high translating speed without complex circuit layout, a high compressing rate and good compressing quality to mitigate or obviate the aforementioned problems.

### SUMMARY OF THE INVENTION

An objective of the present invention is to provide a high speed two-dimensional data translating method with a border extension to generate a good translated result.

Another objective of the present invention is to provide a translating device based on the forgoing method. The translating device needs less memory requirement and the translating device is easy implemented.

Other objectives, advantages and novel features of the invention will become more apparent from the following detailed description when taken in conjunction with the accompanying drawings.

### BRIEF DESCRIPTION OF THE DRAWINGS

FIGS. 1A to 1D are transforming flow chart for translating a two dimensional data to one dimensional data;

FIG. 2 is a diagram of an image having extended pixels generated from a border extension;

FIG. 3 is a process diagram for generating the FIG. 2;

FIGS. 4A and 4B are diagrams of an image with extended pixel processed by a stairway scan way;

FIG. 5 is a block diagram of a translating device for translating method in accordance with the present invention;

FIG. 6, is an arrangement of disposition in memory of data generated from the FIG. 5;

FIGS. 7A, 7B, and 7C are arrangements of disposition in memory of data generated from the conventional Wavelet Transform;

FIG. 8 is a block diagram of a conventional lifting scheme for a wavelet transform;

FIG. 9 is a detailed block diagram of FIG. 8;

FIG. 10 is a block diagram of Integer 5/3 wavelet filter;

FIG. 11 is a block diagram of CDF 9/7 wavelet filter;

FIGS. 12A and 12B are two Symmetric extension for even and odd sequence; and

FIGS. 13A, 13B and 13C are diagrams of an image processed by the conventional signal line or signal column scanning way with conventional boundary extension process.

### DETAILED DESCRIPTION OF THE PREFERRED EMBODIMENT

A method for translating two-dimensional data in accordance with the present invention has a high speed for reading the two-dimension data and does not generate too much unnecessary data during translating the two dimensional data. In addition, the two-dimensional data translated by the method to a good quality of translated result.

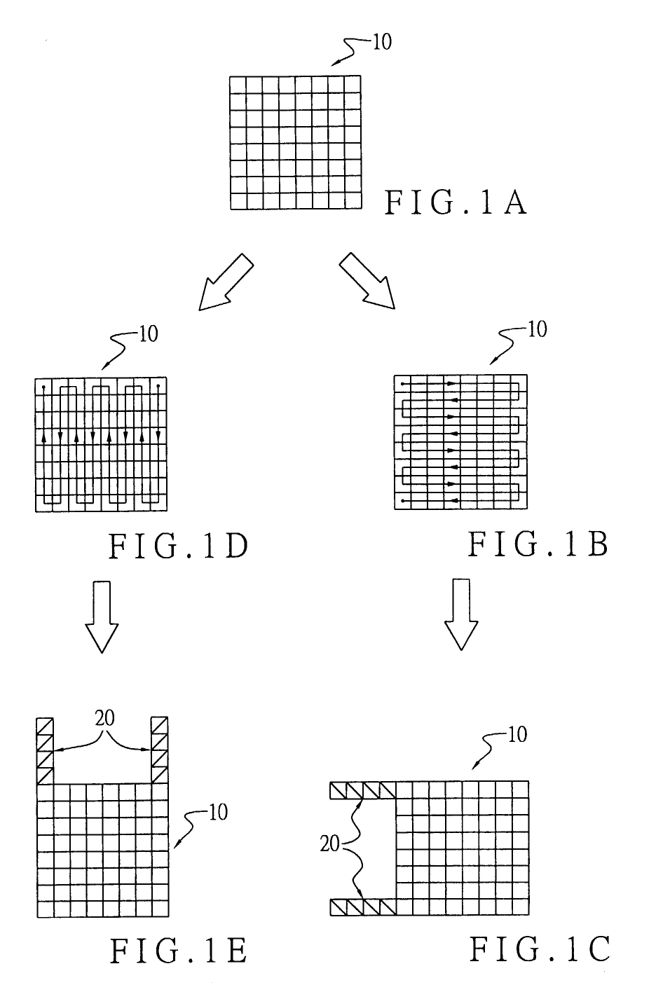

With reference to FIGS. 1A to 1C, the two-dimensional data (10), such as an image, is transformed to one-dimensional data by a stairway scan way. The two-dimensional data is composed of lines and columns, wherein each line and column respectively have two end pixels (not numbered).

The lines of the two-dimensional data is first translated to a first one-dimensional data by a stairway scan way, wherein the two adjacent end pixels of the adjacent lines are connected together to make the two adjacent lines a serial of data. The serial of data is a one-dimensional data having a first and a last end pixels (not numbered). Further, the first and last end pixels of the first one-dimensional data are respectively extended to one boundary extension data (20) by a boundary extension process to be a first one-dimensional data input sequence. Therefore, in the memory each of the first and last rows of the two-dimensional data (10) is extended to one extension data (20). With further reference to FIGS. 1D and 1F, the columns of the two-dimensional data are also translated to a second one-dimensional data by the stairway scan way and the boundary extension process. The forgoing first and second one-dimensional data can be respectively executed by the DWT. The boundary extension process is the symmetric extension.

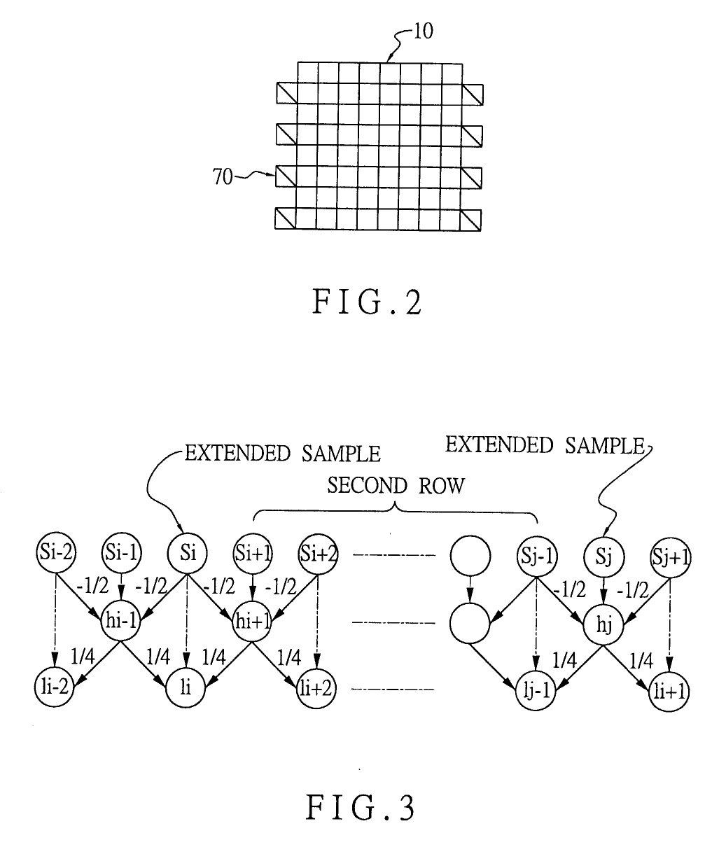

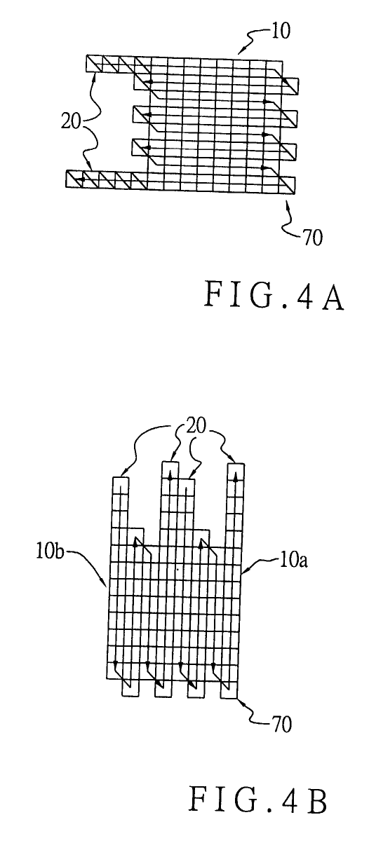

Based on the forgoing description, two-dimensional data is only translated to the first and second one-dimensional data by the stairway scan way. That is, the translating one-dimensional data procedure does not generate too much unnecessary data. In order to increase a compressing rate and a translated quality, the present invention further includes a border extension. That is, with reference to FIG. 2, the lines of the two-dimensional data are processed by the border extension before executing the stairway scan way. Each even row of the two-dimensional data (10) has the two end pixels. Two extension pixels (70) are respectively extended from each end pixel of each even row. The lines of the two-dimensional data with extension pixels (70) are further translated to the one-dimensional data by the stairway scan way and then are processed by boundary extension process and lifting scheme to translate to a one-dimensional data of input sequence for the DWT. With reference to FIG. 4A, the lines of the two-dimensional data (10) with the extension pixels are translated to the one-dimensional data by the stairway scan way and boundary extension process. With reference to FIG. 4B, the columns of the two-dimensional data (10) are also first processed by the border extension to generate the extension pixels and then is further translated to the one-dimensional data.

To further describe details of border extension, the Integer 5/3 is introduced as follow:

With reference to FIGS. 2 and 3, the second line of the forgoing two-dimensional data (10) is an example to show that the second line (not numbered) is processed to have extended pixel(s) and to connect to the first line and third line by the border extension and the stairway scan way. Further, the second line is processed by the lifting scheme. The first and last pixels of the second line are respectively extended to one first and last extended pixels, wherein a value of each extended pixel are changed according to values of the first pixel or last pixel, such as

(A) If the first extended pixel is extended from the first pixel of the even line (second line) of the two-dimensional data, the value Sᵢ of the first extended pixel can be defined by three different ways.

(1) The value “sᵢ” of the first extended pixel is equal to the value sᵢ₋₁ or sᵢ₊₁ of the first pixel, as follows Sᵢ=Sᵢ₋₁ or Sᵢ=Sᵢ₊₁

(2) The value “sᵢ” of the first extended pixel is calculated to closed to 0 by the lifting scheme so that a formula is developed by the lifting scheme. The formula is Sᵢ=⅓└½(sᵢ₋₂+Sᵢ₊₂)−(Sᵢ₋₁+Sᵢ₊₁)┘, wherein Sᵢ₋₁ and sᵢ₊₁ are the adjacent pixels of the Sᵢ.

(3) The value “sᵢ” of the first extended pixel is constant, such as sᵢ=128 or Sᵢ1=0.

(B) If the last extended pixel is extended from the last pixel of the even line (second line) of the two-dimensional data, the value sⱼ of the last extended pixel can be defined by three different ways.

(1) The value sⱼ of the last extended pixel is equal to the value of the adjacent pixels (Sⱼ=Sⱼ₋₁ or Sⱼ=Sⱼ₊₁).

(2) The value “Sⱼ” of the first extended pixel is calculated to closed to 0 by the lifting scheme so that a formula is developed by the lifting scheme. The formula is Sⱼ=⅓└½(Sⱼ₋₂+Sⱼ₊₂)−(Sⱼ₋₁+Sⱼ₊₁)┘, wherein Sⱼ₋₁ and Sⱼ₊₁ are the adjacent pixels of the sⱼ.

(3) The value “sⱼ” of the first extended pixel is constant, such as sⱼ=128 or sⱼ=0.

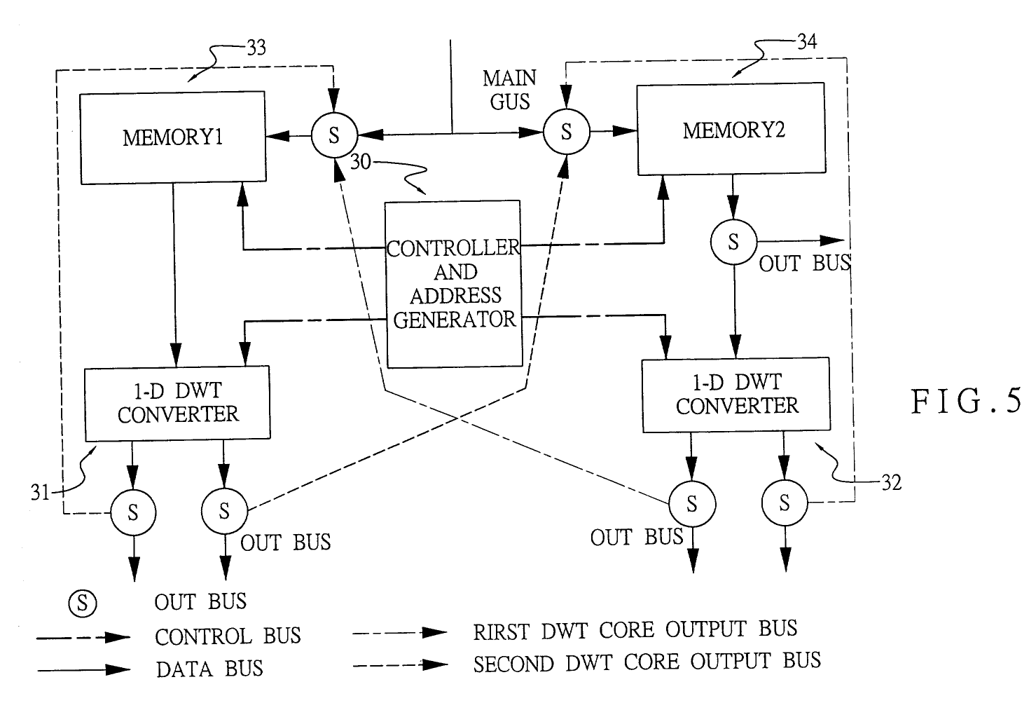

With reference FIG. 5, a device for embodying the above forgoing method for translating two dimensional data of a two-dimensional DWT system has a controller and address generator (30), two one-dimensional (1-D) DWT converters (31, 32), two memories (33, 34). Each of the DWT converter (31, 32) has two input terminals, two output terminals (not numbered) and a wavelet translation. Two output terminals of the each 1-DD WT converter (31, 32) are respectively connected to the two memories through a selector (S) and one input terminal is connected to the controller and address generator (30). Each memory (33, 34) to store a half of two-dimensional data is connected between the input terminal (not numbered) and the controller and address generator (30). Therefore, a size of each memory (33, 34) has at least the half of the two-dimensional data.

Two memories respectively stored two portions of the two-dimensional data, so that two portions are executed to in the device at the time. That is two portion of the two-dimensional data are respectively input to the corresponded the DWT converter (31, 32) to execute the Wavelet Transform controlled by the controller and address generator (30). The DWT with the translating method in the device has the steps of

(1) Initial step.

(2) Row operating.

(3) Column operating

(4) Ending.

In the first step, an image is composed of N×N pixels. The image is cut into two portions each of which is composed of

$$N \times \frac{N}{2}$$

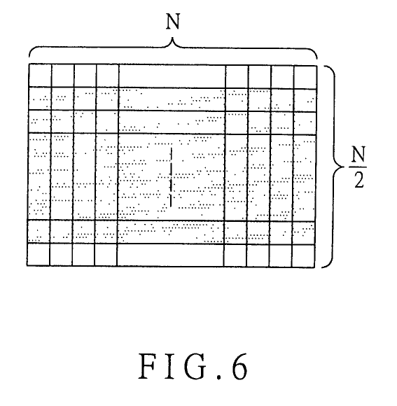

pixels. Each portion is stored in middle addresses of the memory, as a gray area shown in the FIG. 6. If one address can store one pixel, the addresses for storing one portion of the image has

$$N \times ( \frac{N}{2} + 2 )$$

size. The rest addresses of the memory is used to store extension pixels during the border extension and the boundary extension process. Therefore, the rest addresses of the memory has 2×N size.

In the row operating step, the two 1-D DWT converters respectively get the data in serial sequence from the corresponded memories to calculate, not row by row. During getting the serial sequence, the extension pixels are generated and added to the row to be calculated to output low frequency sequence and high frequency sequence by the 1-D DWT converters. The output sequences from the two 1-D DWT converters are alternative stored into two portions of the memories. That is, when the two 1-D DWT converters are finished calculating process, the all low frequency sequences are stored in one memory and the high frequency sequences are stored in the other memory.

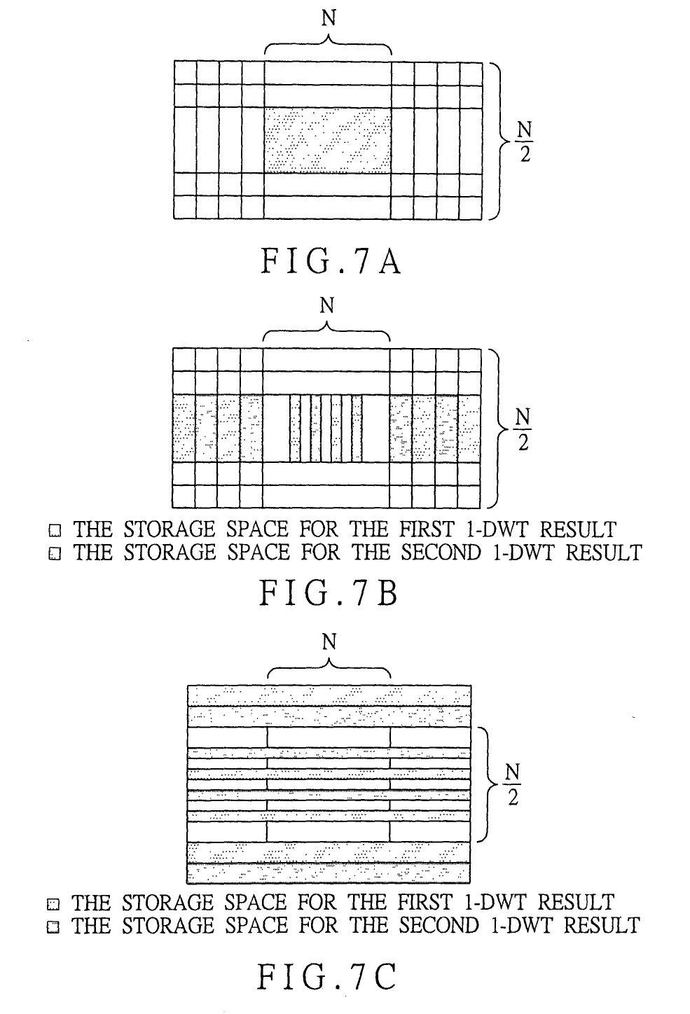

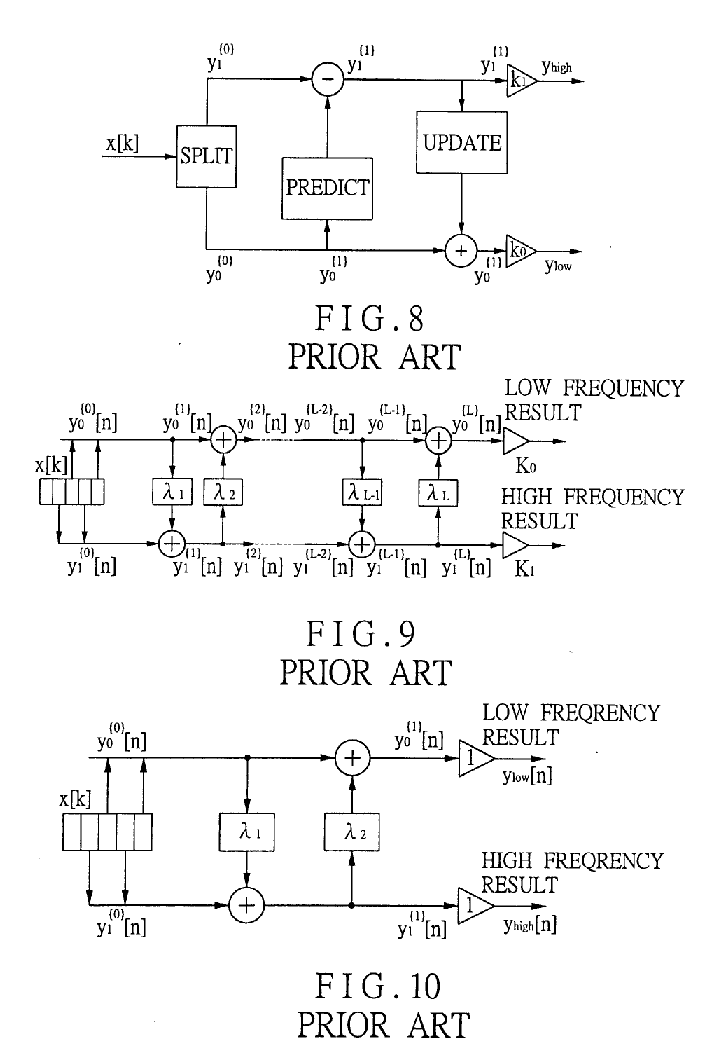

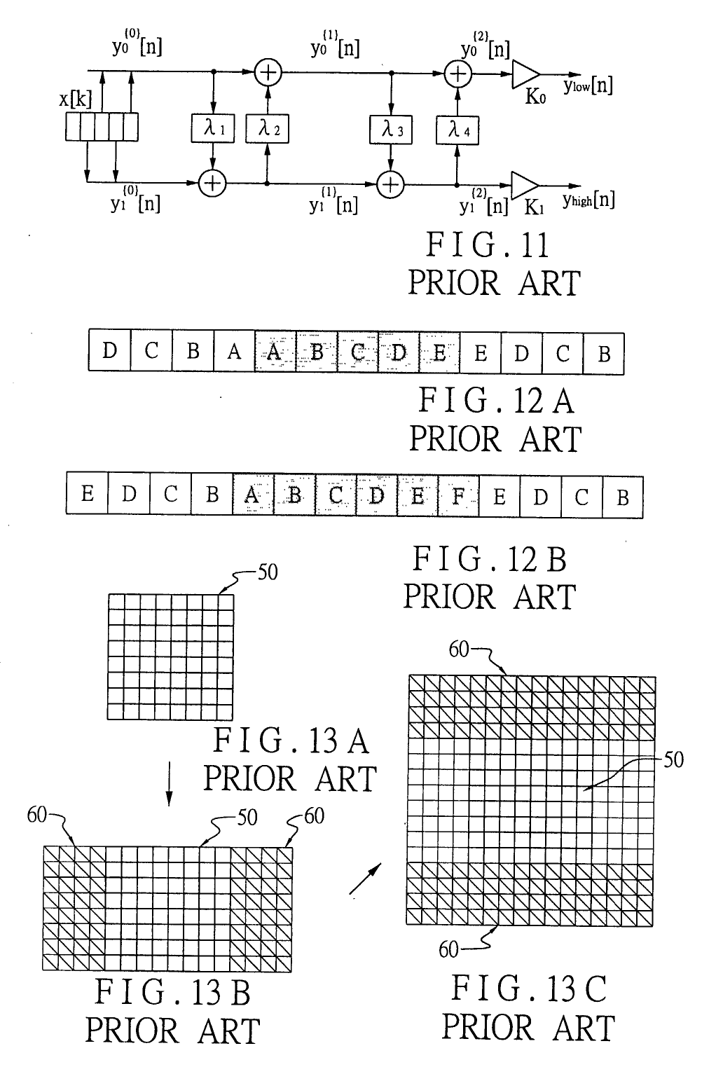

In the columns operating step, two 1-D DWT converters get the all columns of the high frequency sequence or low frequency sequence in serial from the corresponded memories, not column by column. During getting the serial sequence, extension pixels are generated and added to the serial sequence. The output sequences from the two D DWT converters are alternative stored into different memories (denoted by the light and the dark color), as shown in FIG. 7C. That is, when the 1-D DWT converter finished calculating, all low frequency output sequences are stored in one memory and the high frequency sequences are stored in the other memory.

In the ending step, until the third step finishing the image is translated one time by the translating method for a two dimensional DWT system. If the transformed image needs to further be transformed by another time, the second to third steps are executed.

The above device is also to implement DWT with a conventional two-dimensional DWT system. Because in the conventional boundary extension process, each row or column has extended pixels and then input to be executed translated by the DWT. That is, the steps of the executing Wavelet Transform do not change, only some detail steps change, especially the getting a serial sequence way uses row by row or column by column instead of the stairway scan way. At as others changes are described as follow:

In the first step, an image is composed of N×N pixels. The image is cut into two portions each of which is composed of

$$N \times \frac{N}{2}$$

pixels. Each portion is stored in middle addresses of the memory, as a gray area shown in the FIG. 7A. If one address can store one pixel, the addresses for storing one portion of the image has

$$N \times ( \frac{N}{2} + 2 )$$

size. Number of the extension pixels is defined to α, the reset addresses of the memory has (N×α)+2×α² size and are used to prepare to store extension pixels of the image. Therefore, total size of the memory is

$$( N \times \frac{N}{2} ) + ( N \times α ) + 2 \times α .$$

In the row operating step, the two 1-D DWT converters get the one-dimensional data in row by row from the corresponded memories to calculate at the same time. When each row is got from the memory, the extension pixels are generated and added to the row to be calculated to output low frequency sequence and high frequency sequence by the 1-D DWT converters. The output sequences from the each 1-D DWT converters are alternative stored into two memories (denoted by the light and the dark color), as shown in FIG. 7B. That is, when the two 1-D DWT converters are finished calculating process, the all low frequency sequences are stored in one memory and the high frequency sequences are stored in the other memory.

In the columns operating step, two 1-D DWT converters get the all columns of the high frequency sequence or low frequency sequence in column by column from the corresponded memories. During getting each column, the extension pixels are generated and added to each column by the conventional boundary extension process. The output sequences from the each 1-D DWT converters are alternative stored into two memories, (denoted by the light and the dark color), as shown in FIG. 7C. That is, when the 1-D DWT converter finished calculating, all low frequency sequences are stored in one memory and the high frequency sequences are stored in the other memory.

In the ending step, until the third step finishing the image is translated one time by the wavelet transform. If the translated image needs to further be translated by another time, the second to third steps are executed.

Based on the above description, the present invention proposed a translating method for DWT to translate two-dimensional. The image having two-dimensional data can be the input data for the wavelet transform. That is, the hardware not only does not use large size memory to support the Wavelet transform with the boundary extension process, but also the calculating speed is fast, too. Besides, the Wavelet transform with the boundary extension process in accordance with the present invention is suitable to the JPEG2000 standard.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for translating two-dimensional data of a DWT system, wherein a two-dimensional data is composed of lines and columns, wherein the method comprises:
translating the lines of the two-dimensional data to a first one dimensional data by a stairway scan way, wherein each line has two end pixels and the two adjacent end pixels of the adjacent lines are connected together to make the lines a serial of data, which is a first one dimensional data having a first and a last end pixels;
extending the first and last end pixels of the first one-dimensional data by a boundary extension process to translate to a first one-dimensional data input sequence;
translating the columns of the two-dimensional data to a second one dimensional data by the stairway scan way, wherein the second one dimensional data has a first and last end pixels; and
extending the first and last end pixels of the second one-dimensional data by a boundary extension process to translate to a second one-dimensional data input sequence.

2. The method as claimed in claim 1, wherein at least one end pixel of a part of the lines or the columns of the two-dimensional data are extended to multiple extended pixels before executing the stairway scan way.

3. The method as claimed in claim 2, wherein the lines or columns having the extended pixels are even lines or columns.

4. The method as claimed in claim 1, wherein the boundary extension process is a symmetric extension.

5. A device for translating two-dimensional data of a DWT system, comprising:
a controller and address generator;
two memories each of which is connected to the controller and address generator to store a half of a two-dimensional data; and
two one-dimensional 1-D DWT converters each of which has two inputs, two outputs and a wavelet transform process, wherein the two inputs of the one-dimensional 1-D DWT converter are respectively connected to the memory and the controller and address generator and the two outputs are respectively connected to the two memories.

6. The device as claimed in claim 5, wherein a size of each memory is about the half of the two-dimensional data.

7. The device as claimed in claim 5, wherein a compressing process is executed by the controller and address generator, the compressing process comprises steps of:
(1) Initial step, wherein
an image composed of N×N pixels is cut into two portions each of which is composed of
$$N \times \frac{N}{2}$$
pixels, whereby each portion is stored in middle addresses of the memory and the rest addresses of the memory having 2×N pixels are used to prepare store extension pixel;
(2) Row operating, wherein
the two 1-D DWT converters get the data in serial sequence from the corresponded memories to calculate and execute a boundary extension process to extend the pixels during getting the serial sequence, whereby output low frequency and high frequency sequences from the each 1-D DWT converters are alternative stored into the two memories; and
(3) Column operating, wherein
two 1-D DWT converters get the high frequency sequence and low frequency sequence in serial from the corresponded memories to executed Wavelet transform method to output new high frequency sequence and low frequency sequence that are alternative stored into different memories.

8. The device as claimed in claim 7, wherein a compressing process further comprises a ending step, wherein if the compressed image needs to further be compressed by another time, the second to third steps are executed.
